(19) United States
(12) Patent Application Publication
(10) Pub. No.: US 2006/0249343 A1
(43) Pub. Date: Nov. 9, 2006

(54) Rotary damper

(75) Inventors: Edgar Prottengeier, Nurnberg (DE); Wolfgang Nagl, Allersberg (DE); Glen Robert Wilkinson III, Paw Paw, MI (US)

Correspondence Address: BROWDY AND NEIMARK, P.L.L.C.;624 NINTH STREET, NW, SUITE 300, WASHINGTON, DC, 20001-5303, US

(73) Assignee: SUSPA Holding GmbH, Altdorf (DE)

(21) Appl. No.: 11/373,486

(22) Filed: Mar. 13, 2006

(30) Foreign Application Priority Data
May 6, 2005 (DE) 10 2005 021 085.6
Jan. 4, 2006 (DE) 10 2006 000 900.2

(51) Int. Cl. F16F 11/00

(52) U.S. Cl. 188/381

(57) ABSTRACT

In a rotary damper for damping a motion of rotation, in particular for damping the motion of rotation of a tailgate of a vehicle, it is provided, with a view to achieving a damping behaviour that corresponds to raised demands for convenience, that at least one compressible frictional damping lining is disposed within the housing, acting between a shaft and the housing for damping the motion of rotation of a shaft along a direction of rotation.

### BACKGROUND OF THE INVENTION

1. Field of the Invention

The invention relates to a rotary damper for damping a rotary motion, in particular for damping the rotary motion of a tailgate of a vehicle.

2. Background Art

For convenience of loading and unloading, vehicles, in particular pick-ups and sport-utility vehicles, have tailgates which must be opened in the direction of gravity and closed against gravity. Tailgates of the generic type are provided with ropes or chords so that a defined angle of opening is obtained. In more recent designs, the ropes or chords unwind from spring-loaded rolls, this braking the opening of the tailgates. Ropes or chords of the species, with or without spring-loaded rolls, no longer meet a customer's higher demands for convenience of handling.

### SUMMARY OF THE INVENTION

It is an object of the invention to embody as simple as possible a rotary damper at lowest possible costs, which is simultaneously reliable, meeting a customer's high demands for convenience in particular upon opening and closing a tailgate.

This object is attained in a rotary damper for damping a motion of rotation, in particular for damping the motion of rotation of a tailgate of a vehicle, comprising a housing; a cover which closes the housing; a shaft which is mounted in the housing rotatably about an axis of rotation and which is operable by torque that is to be damped; and at least one compressible frictional damping lining which is disposed in the housing and acts between the housing and the shaft for damping a motion of rotation of the shaft along a direction of rotation. The gist of the invention resides in that at least one compressible frictional damping lining is disposed in a housing, damping rotation in a direction of rotation between the shaft and the housing. During a rotary motion, the at least one frictional damping lining helps build up a moment of friction on the one hand and a moment of spring on the other. The moment of friction and the moment of spring are easily adjustable by way of material properties and the arrangement of the compressible frictional damping lining. By use of a compressible frictional damping lining, the rotary damper can be sealed more easily than fluid- or gas-filled rotary dampers, thus being reliable and less expensive. As a result of its easily adjustable damping behaviour, the rotary damper can be flexibly suited to a customer's varying demands for convenience, in particular involving the opening and closing of tailgates in vehicles.

Additional features and details of the invention will become apparent from the description of several exemplary embodiments, taken in conjunction with the drawings.

### BRIEF DESCRIPTION OF THE DRAWINGS

FIG. 1 is an exploded view of a rotary damper according to a first embodiment;

FIG. 2 is an axial sectional view of the rotary damper of FIG. 1;

FIG. 3 is an exploded view of a rotary damper according to a second embodiment;

FIG. 4 is an axial sectional view of the rotary damper of FIG. 3;

FIG. 5 is an exploded view of a rotary damper according to a third embodiment;

FIG. 6 is an axial sectional view of the rotary damper of FIG. 5;

FIG. 7 is an exploded view of a rotary damper according to a fourth embodiment;

FIG. 8 is an axial sectional view of the rotary damper of FIG. 7;

FIG. 9 is an exploded view of a rotary damper according to a fifth embodiment;

FIG. 10 is an axial sectional view of the rotary damper of FIG. 9;

FIG. 11 is an exploded view of a rotary damper according to a sixth embodiment;

FIG. 12 is an axial sectional view of the rotary damper of FIG. 11;

FIG. 13 is an exploded view of a rotary damper according to a seventh embodiment;

FIG. 14 is a sectional view of the rotary damper of FIG. 13;

FIG. 15 is an illustration, on an enlarged scale, of a detail of the rotary damper of FIG. 14 in a position of free running;

FIG. 16 is an illustration, on an enlarged scale, of a detail of the rotary damper of FIG. 14 in a position of friction;

FIG. 17 is an exploded view of a rotary damper according to an eighth embodiment; and

FIG. 18 is an axial sectional view of the rotary damper of FIG. 17.

### DESCRIPTION OF PREFERRED EMBODIMENTS

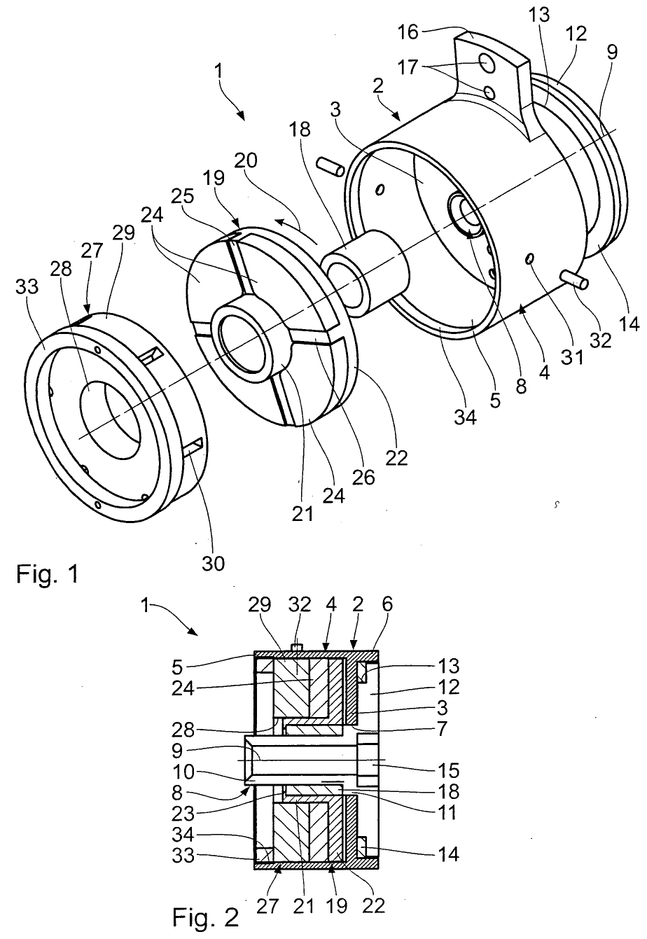

The following is a description of a first embodiment of a rotary damper 1, taken in conjunction with FIGS. 1 and 2. The rotary damper 1 serves in particular for damping the rotary motion of a tailgate of a vehicle. The rotary damper 1 comprises a housing 2 with a bottom plate 3 and an annular cylindrical housing wall 4 joined thereto. The housing wall 4 projects bilaterally from the bottom plate 3 and is divided by it into a first housing-wall portion 5 and a second housing-wall portion 6. The bottom plate 3 is centrally provided with a round bore 7, in which a shaft 8 is disposed, having the cross-sectional shape of a hollow cylinder. The shaft 8 is rotatable about an axis of rotation 9 which runs centrally through the bore 7. By alternative, the shaft 8 may also be a solid cylinder.

The shaft is divided into a first shaft portion 10 and an adjacent second shaft portion 11 of a diameter that exceeds that of the first shaft portion 10. The second shaft portion 11 is housed in the bore 7 of the bottom plate 3, slightly standing out in the direction of the first housing-wall portion 5. A bearing disk 12, which is one piece with the shaft 8, adjoins the second shaft portion 11. The bearing disk 12 has such a diameter and thickness that it is able of being accommodated within the second housing-wall portion 6 and is substantially in alignment with the free end of the second housing-wall portion 6. Adjoining the bottom plate 3, the bearing disk 12 comprises an annular sliding-ring recess 13, in which is disposed a sliding ring 14 that bears against the bottom plate 3 and the bearing disk 12. Concentrically of the axis of rotation 9, the bearing disk 12 comprises an internally polygonal recess 15 which is for example connectable to a tailgate for torque transmission. For fixing the rotary damper 1 in particular to a vehicle, a fixing link 16 is disposed on the housing wall 4, extending radially outwards and having two fixing bores 17.

A sleeve-type free-running element 18 and a rotary piston 19 that is fixed thereto are disposed on the first shaft portion 10, the free-running element 18 bearing against the second shaft portion 11. The free-running element 18 is constructed such that it permits torque transmission from the shaft 8 to the rotary piston 19 in a direction of rotation 20, whereas no torque transmission is possible counter to the direction of rotation 20.

The rotary piston 19 comprises a hollow cylindrical first rotary-piston portion 21 and a disk-type second rotary-piston portion 22 which is integrally formed thereon and projects radially outwards. The rotary piston 19 is fixed by the first rotary-piston portion 21 to the free-running element 18 by means of press-fit or alternatively by means of positive fit, for example an indentation, with an encircling annular shoulder 23, which is disposed on the first rotary-piston portion 21 and extends in the direction of the axis of rotation 9 and bears laterally against the free-running element 18, securing the rotary piston 19 against displacement in the direction of the bottom plate 3. The second rotary-piston portion 22 is spaced from, and substantially parallel to, the bottom plate 3.

Frictional damping linings 24 in the form of ring segments are disposed on the side of the second rotary-piston section 22 that is turned away from the bottom plate 3. The frictional damping linings 24 bear against a first stop 25 and a second stop 26 as well as against the first and second rotary-piston portion 21, 22. The first stop 25 of a frictional damping lining 24 is simultaneously the second stop 26 of the respectively adjoining frictional damping lining 24. The stops 25, 26 are formed integrally on the rotary piston 19 and extend radially outwards, starting from the first rotary-piston section 21. The rotary piston 19, together with the frictional damping linings 24 disposed thereon, is rotationally symmetric to an angle of 90°.

The frictional damping linings 24 consist of an elastomer which is compressible in the direction of rotation 20, in particular of foamed, microporous polyurethane. The frictional damping linings 24 have a density ranging between 250 kg/m³ and 750 kg/m³, in particular between 350 kg/m³ and 650 kg/m³, and in particular between 450 kg/M³ and 550 kg/m³. The frictional damping linings 24 have pores of a diameter in the range of tenths of millimeters, the pores taking a volume within the volume of the frictional damping linings 24 of 70% to 40%, in particular of 65% to 45%, and in particular of 60% to 50%.

Opposite the bottom plate 3 the housing 2 is closed by an annular cover 27. The cover 27 has a bore 28 which the shaft 8 and, in part, the free-running element 18 and the first rotary-piston portion 21 are guided through. The cover 27 bears against the first rotary-piston portion 21 and against the frictional damping linings 24. For being fixed, the cover 27 has grooves 30 which extend on its outer wall 29 along the axis of rotation 9 and which securing bolts 32 engage with which are inserted through the bores 31 in the housing wall 4. For further fixation along the axis of rotation 9, provision is made for a cover nut 33 with an external thread which, by its external thread is screwed into an internal housing thread 34 which is disposed in the vicinity of the free end of the first housing-wall portion 5. By alternative of the securing bolts 32, a connection by positive fit of the cover 27 to the housing 2 is conceivable, with a motion of the cover 27 along the axis of rotation 9 still being possible for adjustment of the press-fit by means of the cover nut 33. Furtheron, the cover 27 may also be completely joined to the housing 2 by embossing. Also a securing ring can be used instead of the cover nut 33.

The mode of operation of the rotary damper 1 is described in the following. The shaft 8 is set rotating about the axis of rotation 9 in the direction of rotation 20 for example when a tailgate of a vehicle is opened. The free-running element 18 transmits to the rotary piston 19 the torque that is exercised on the shaft 8. Owing to the respectively second stop 26, the frictional damping linings 24 are entrained by the rotary piston 19 so that they too move in the direction of rotation 20 about the axis of rotation 9. During the motion of rotation, the frictional damping linings 24 rub against the cover 27 which is stationary in relation to the housing 2. The moment of friction thus produced counteracts the motion of rotation. The moment of friction is adjustable by the cover nut 33 being screwed in and out, the press-fit of the cover 27 to the frictional damping linings 24 thus being modifiable.

Via the frictional damping linings 24, the acting moment of friction is transmitted to the respectively second stops 26 and the rotary piston 19. For this purpose, the frictional damping linings 24 are compressed while being rubbed until a moment of spring is occasioned stationarily, corresponding to the moment of friction. This moment of spring is transmitted to the respectively second stops 26. The damping behaviour of the rotary damper 1 is adjustable by way of the material properties of the elastomer. If the frictional damping linings 24 have a high density and thus a low volume of the pores, then the frictional damping linings 24 are very stable dimensionally i.e., hardly compressible. That kind of frictional damping linings 24 produce a strong damping effect. If, however, the frictional damping linings 24 have a low density and thus a high volume of pores, then they are easily compressible. As compared to the above case, that kind of frictional damping linings 24 produce a lower damping effect.

Upon rotation of the shaft 8 against the direction of rotation 20, for example when a tailgate is shut, the free-running element 18 becomes active, preventing any torque transmission from the shaft 8 to the rotary piston 19. The frictional damping linings 24 do not work upon rotation counter to the direction of rotation 20. After a motion of rotation, the frictional damping linings 24 resume their original shape and bear against the first and second stop 25, 26, respectively—as seen in FIG. 1.

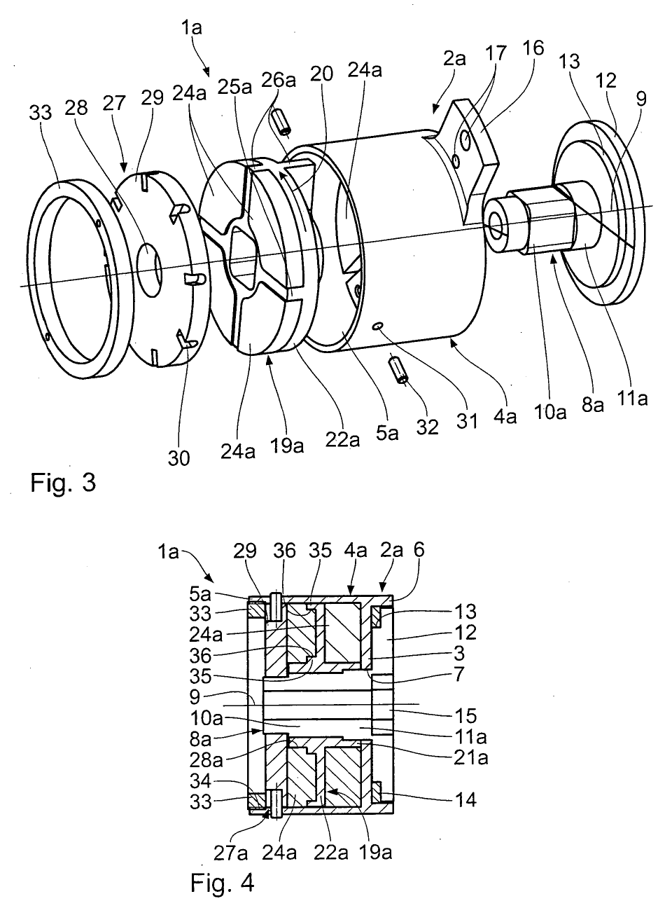

A second exemplary embodiment is going to be described below, taken in conjunction with FIGS. 3 and 4. Constructionally identical parts have the same reference numerals as in the first embodiment, to the description of which reference is made. Parts that differ constructionally, but are identical functionally, have the same reference numerals with an a annexed. The substantial difference from the first embodiment resides in the design of the rotary piston 19a and in the arrangement of the frictional damping linings 24a. In the vicinity of the first shaft portion 10a, the shaft 8a is partially substantially square in cross-sectional shape so that the first rotary-piston portion 21a is positively connectable to the shaft 8a. The second shaft portion 11a constitutes a stop for the rotary piston 19a, with the first rotary-piston portion 21a bearing against, and encompassing, the second shaft portion 11a.

The second rotary-piston portion 22a is disposed centrally in relation to the first rotary-piston portion 21a and extends radially outwards. Frictional damping linings 24a are disposed on both sides of the second rotary-piston portion 22a along the axis of rotation 9. For differentiation, these frictional damping linings 24a are called cover-side frictional damping linings 24a and bottom-side frictional damping linings in dependence on their arrangement in the rotary damper 1a.

The cover-side frictional damping linings 24a are disposed between the second rotary-piston portion 22a and the cover 27, bearing against the rotary piston 19a, the cover 27 and the housing wall 4a. The second rotary-piston portion 22a comprises holding shoulders 35 which are spaced apart in the direction of the cover 27 and which engage with holding grooves 36 of corresponding shape of the cover-side frictional damping linings 24a. The cover-side frictional damping linings 24a have a high density.

The bottom-side frictional damping linings 24a are disposed between the second rotary-piston portion 22a and the bottom plate 3 and bear against the rotary piston 19a, the housing wall 4a and the bottom plate 3. The bottom-side frictional damping linings 24a have the shape of a ring segment which has an angle of approximately 180°. The bottom-side frictional damping linings 24a are respectively disposed between a first stop 25a, which is stationary in relation to the housing 2a and the bottom plate 3, and a second stop 26a, which is stationary in relation to the rotary piston 19a. The first stop 25a is fixed to the bottom plate 3, bearing against it and the housing wall 4a. The second stop 26a is formed in one piece with the first and second rotary-piston portion 21, 22. When the rotary damper 1a is assembled, the first stop 25a of a bottom-side frictional damping lining 24a adjoins the second stop 26a of an adjacent bottom-side frictional damping lining 24a. The bottom-side frictional damping linings 24a have a lower density than the cover-side frictional damping linings 24a.

When the shaft 8a is actuated by torque and set rotating in the direction of rotation 20 about the axis of rotation 9, then the rotary piston 19a is entrained as a result of the positive fit. Upon rotation, the cover-side frictional damping linings 24a rub on the cover 27, producing a moment of friction that acts counter to the direction of rotation 20. The bottom-side frictional damping linings 24a are simultaneously compressed during the motion of rotation. This results from the fact that, during the motion of rotation, the first and second stop 25a, 26a of the bottom-side frictional damping linings 24a are rotated one in relation to the other about the axis of rotation 9. The compression produces a moment of spring that depends on the angle of rotation and counteracts the motion of rotation.

The bottom-side frictional damping linings 24a have a progressive spring characteristic, the range of spring and the spring characteristic depending on the density of the frictional damping linings 24a. The bottom-side frictional damping linings 24a, when correspondingly designed, are compressible by 80% of their initial volume, maximal compression being achievable at minimal density. Upon compression, the pores of the elastomer are compressed first and then the elastomer itself, which results in the progressive spring characteristic.

During the motion of rotation, the first stops 25a of the bottom-side frictional damping linings 24a work as a limit element on the one hand and restrict the angle of rotation on the other, with preferred restricted angles of rotation being in the range of 90° or 180°. Upon rotation, the bottom-side frictional damping linings 24a rub on the bottom plate 3 and the housing wall 4a so that a moment of friction is added to the moment of spring.

By compression of the bottom-side frictional damping linings 24a, a moment of spring that depends on the angle of rotation is easy to produce, as a result of which the damping behaviour of the rotary damper 1a is easily adjustable in wide ranges. Upon a motion of rotation against the direction of rotation 20, the moment of spring built up by compression works in support of, for example, shutting a tailgate. The supporting effect can be improved by the bottom-side frictional damping linings 24a being mounted by corresponding pre-load.

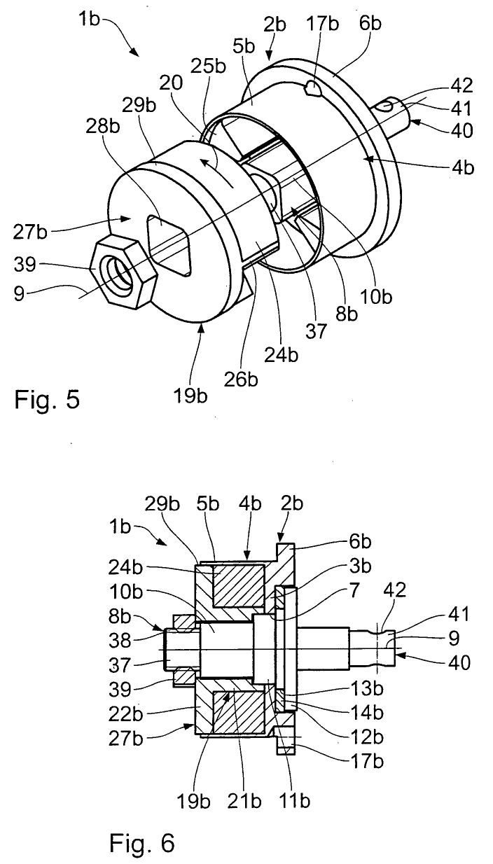

A third exemplary embodiment is going to be described below, taken in conjunction with FIGS. 5 and 6. Constructionally identical parts have the same reference numerals as in the first embodiment, to the description of which reference is made. Parts that differ constructionally, but are identical functionally, have the same reference numerals with a b annexed. The substantial difference from the foregoing embodiments resides in that the rotary piston 19b is integral with the cover 27b and in that the second rotary-piston portion 22b is identical with the cover 27b. The cover 27b is positively joined to the shaft 8b. The first stop 25b of a frictional damping lining 24b is stationary in relation to the housing 2b and fixed thereto or to the bottom plate 3b. The first stops 25b have the shape of a wedge in the direction of the axis of rotation 9. The second stops 26b are formed in one piece with the rotary piston 19b and the cover 27b and extend radially outwards, proceeding from the rotary piston 19b. The frictional damping linings 24b bear against the bottom plate 3b, the-housing wall 4b, the rotary piston 19b and the cover 27b. For the cover 27b to be secured axially, the shaft 8b comprises a first shaft projection 27b with an external thread 38. When the rotary damper 1b has been assembled, the shaft projection 37 stand out from the cover 27b so that a securing nut 39 can be screwed on the external thread 38 of the shaft projection 37. For the shaft 8b to be actuated by torque, a second shaft projection 40 adjoins the bearing disk 12b. The second shaft projection 40 comprises a fastening portion 41 of reduced diameter with a securing bore 42 for insertion of a torque-transmitting bolt. For the housing 2b to be fixed to a vehicle, the second housing-wall portion 6b projects radially outwards and has a fixing bore 17b.

Upon rotation of the shaft 8b about the axis of rotation 9 in the direction of rotation 20, the frictional damping linings 24b rub on the bottom plate 3b, the housing wall 4b and the cover 27b, simultaneously being compressed one in relation to the other by the rotation of the first and second stops 25b, 26b. The rubbing produces a moment of friction and the compression a moment of spring which counteract, and damp, the motion of rotation. The moment of spring acts in support during a motion of rotation counter to the direction of rotation 20. The first stops 25b moreover accomplish a restriction of the motion of rotation.

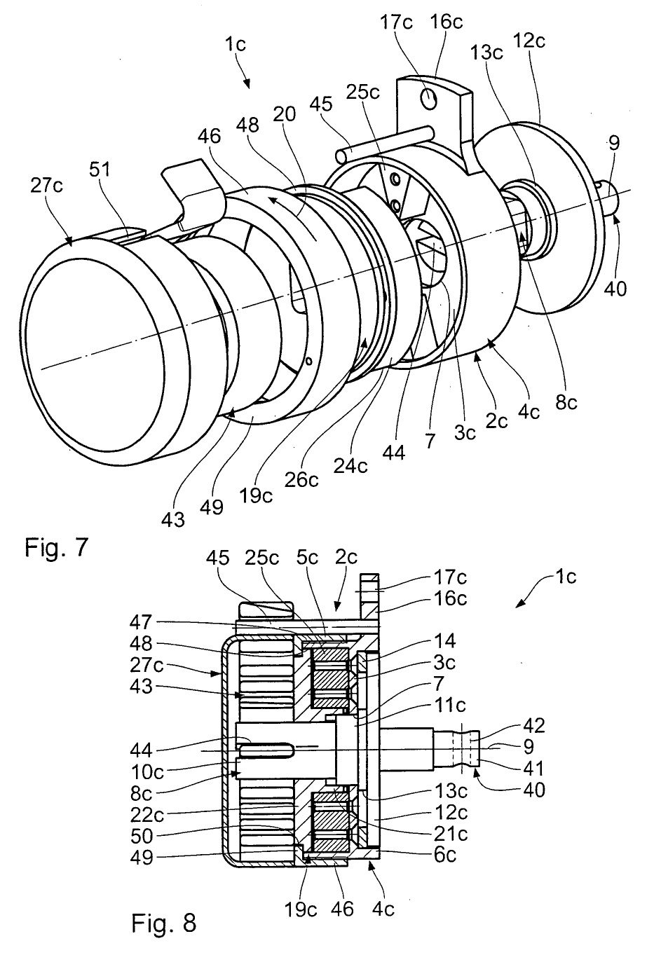

A fourth exemplary embodiment is going to be described below, taken in conjunction with FIGS. 7 and 8. Constructionally identical parts have the same reference numerals as in the first embodiment, to the description of which reference is made. Parts that differ constructionally, but are identical functionally, have the same reference numerals with a c annexed. The substantial difference from the foregoing embodiments resides in that a spring element 43 in the form of a helical spring is provided in addition to the frictional damping linings 24c. A first end of the helical spring 43 is fixed in a slit 44 which is disposed in the first shaft portion 10c. A second, free end of the helical spring 43 is bent in the vicinity of the fixing link 16c of the housing 2c and hooked together with a bolt 45 which extends from the fixing link 16c. The bolt 45 is fixed by press-fit to one of the fixing bores 17c. The frictional damping linings 24c are disposed between respective first and second stops 25c, 26c, the first stops 25c being fixed to the bottom plate 3c by means of rivets. The second stops 26c and the rotary piston 19c form one piece. The rotary piston 19c is positively joined to the shaft 8c. For the rotary piston 19c to be fixed axially, provision is made for a closing nut 46 which is substantially annular and has an internal thread 47. The closing nut 46 is screwed on to a rotary-piston external thread 48. The internal thread 47 is formed on an annular shoulder 49 which is integral with the closing nut 46 and which simultaneously fixes the rotary piston 19c in the axial direction. To this end, the rotary piston 19c comprises a recess 50 which corresponds in shape to the annular shoulder 49 and on which the external thread 48 is disposed. The helical spring 43, when mounted, bears against the rotary piston 19c and precisely not against the closing nut 46. The cover 27c is cap-shaped, having a slit 51 which extends along the axis of rotation 9 and which enables the second, free end of the helical spring 43 to pass through. The cover 27c can be placed on the closing nut 46 by means of a plug-and-socket connection in such a way that the cover 27c and the closing nut 46 are in alignment. For actuation of the shaft 8c, a shaft projection 40 is provided, corresponding to the third embodiment.

During a motion of rotation of the shaft 8c in the direction of rotation 20, the frictional damping linings 24c rub on the bottom plate 3c, the housing wall 4c and the rotary piston 19, which is known, with the frictional damping linings 24c being simultaneously compressed by the motion of rotation. The motion of rotation is thus damped in known manner. At the same time as the compression of the frictional damping linings 24c takes place, the helical spring 43, which supports itself on the first shaft portion 10c and the bolt 45, is loaded. Loading the helical spring 43 produces a moment of spring which counteracts the motion of rotation. The moment of the helical spring 43 acts in addition to the moment of spring of the compressed frictional damping linings 24c. Upon a motion of rotation counter to the direction of rotation 20, the spring moment of the helical spring 43 works in additional support. Pre-loading the helical spring 43 renders the supporting moment of spring easily adjustable.

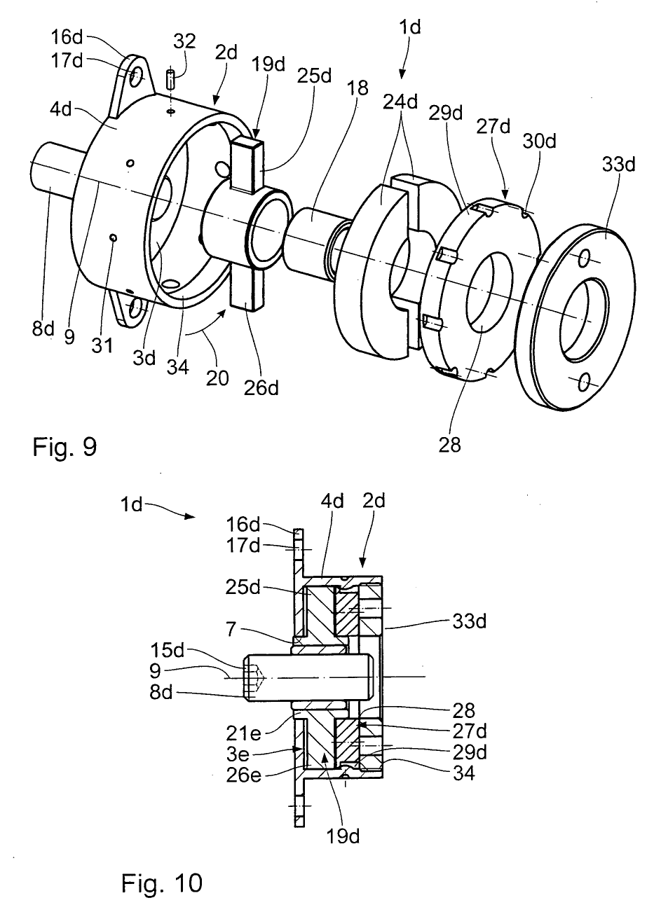

A fifth exemplary embodiment will be described below, taken in conjunction with FIGS. 9 and 10. Constructionally identical parts have the same reference numerals as in the first embodiment, to the description of which reference is made. Parts that differ constructionally, but are identical functionally, have the same reference numerals with a d annexed. The substantial difference from the first embodiment resides in the design of the rotary piston 19d. The rotary piston 19d does not possess any disk-type second rotary-piston portion 22 that projects radially outwards so that the stops 25d, 26d, which are integral with the rotary piston 19d, extend radially outwards in the way of wings. The stops 25d, 26d are disposed centrally on the rotary piston 19d along the axis of rotation 9. For being mounted, the rotary piston 19d passes into the bore 7 of the bottom plate 3d and into the bore 28 of the cover 27d. The frictional damping linings 24d bear against the stops 25d, 26d as well as against the rotary piston 19d. They further bear against the housing 2d and the cover 27d for a moment of friction to be produced. The free-running element 18 is disposed in a manner known per se between the rotary piston 19d and the shaft 8d. A bearing disk 12 with a sliding-ring recess 13 and a sliding ring 14 is not provided in this embodiment. By alternative of the stops 25d, 26d which are opposed diametrically, several first stops 25d and several second stops 26d can be provided, corresponding to the first embodiment. As regards the mode of operation, reference is made to the mode of operation of the first embodiment.

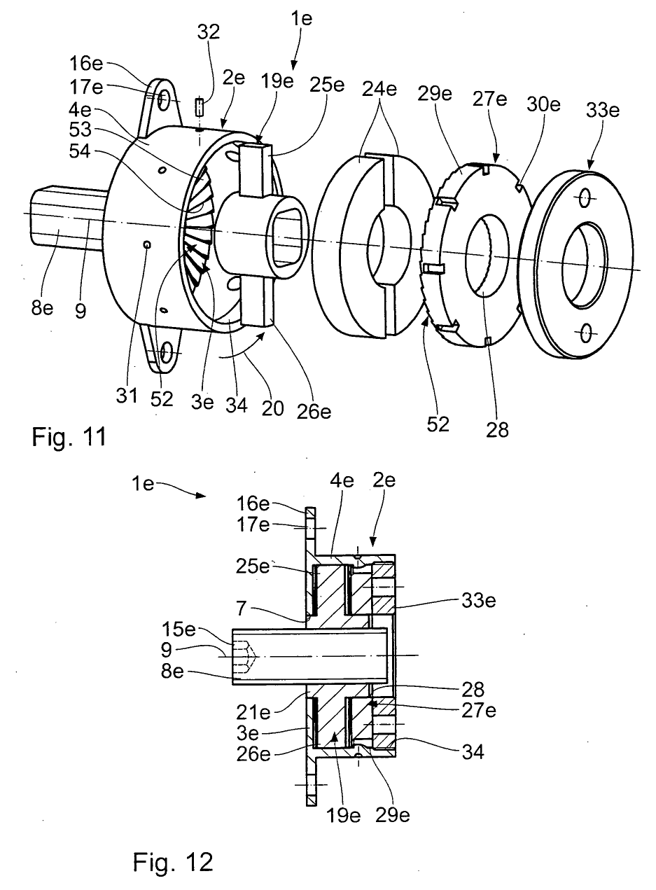

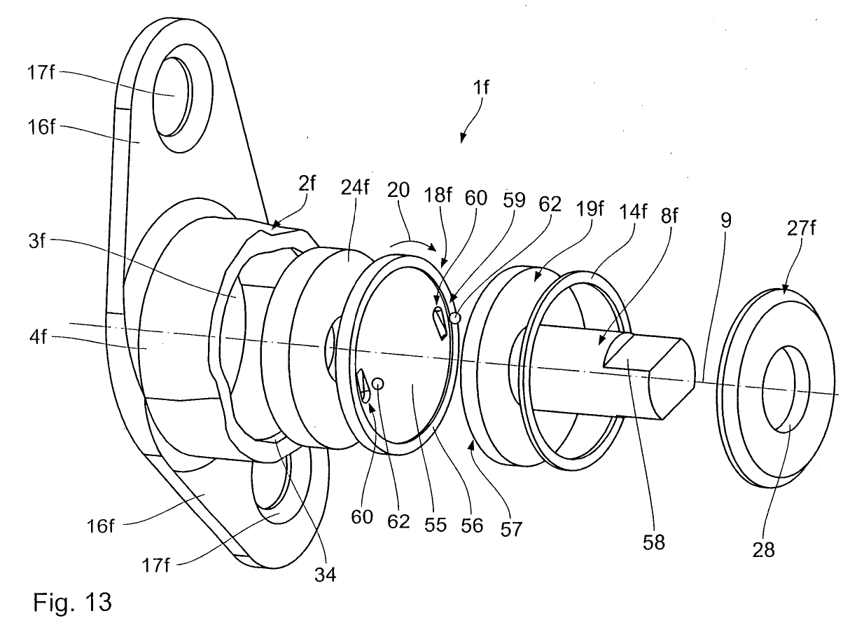

A sixth exemplary embodiment is going to be described below, taken in conjunction with FIGS. 11 and 12. Constructionally identical parts have the same reference numerals as in the first embodiment, to the description of which reference is made. Parts that differ constructionally, but are identical functionally, have the same reference numerals with an e annexed. The substantial difference from the foregoing embodiments resides in that the bottom plate 3e and the cover 27e, on sides that are turned towards the frictional damping linings 24e, have ribs 52 that extend radially outwards. For a moment of friction, dependent on the direction of rotation, to be produced, the ribs 52 are shaped in the way of a ramp in the direction of rotation 20. They have a flat first ramp portion 53 and a steep second ramp portion 54. A free-running element 18 is not provided in this embodiment. Upon rotation of the rotary piston 19e in the direction of rotation 20, the frictional damping linings 24e touch the steep second ramp portions 54 of the ribs 52 so that a high moment of friction is produced. Upon rotation of the rotary piston 19e counter to the direction of rotation 20, the frictional damping linings 24e tough the flat first ramp portions 53 of the ribs 52 so that an inferior moment of friction is produced. As regards the further mode of operation, reference is made to the mode of operation of the foregoing embodiments.

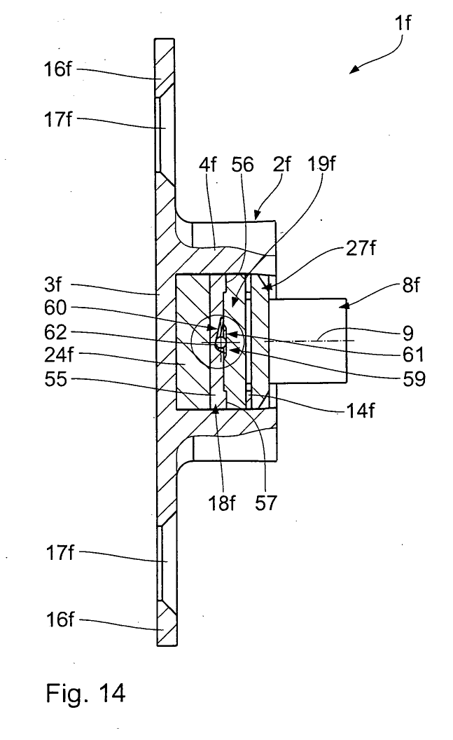

A seventh exemplary embodiment is going to be described below, taken in conjunction with FIGS. 13 to 16. Constructionally identical parts have the same reference numerals as in the first embodiment, to the description of which reference is made. Parts that differ constructionally, but are identical functionally, have the same reference numerals with an f annexed. The substantial difference from the first embodiment resides in the arrangement and design of the free-running element 18f.

The free-running element 18f is substantially disk-shaped and disposed between the rotary piston 19f and the frictional damping lining 24f along the axis of rotation 9. For production of a moment of friction, the free-running element 18f has a friction disk 55 which is concentric of the axis of rotation 9 and turned towards the frictional damping lining 24f. The frictional damping lining 24f is shaped in the way of a ring and disposed between the bottom plate 3f and the friction disk 55. The friction disk 55 has an encircling annular shoulder 56 which is turned towards the rotary piston 19f and extends into a correspondingly shaped annular groove 57 of the rotary piston 19f. The rotary piston 19f is disk-shaped and integral with the shaft 8f which runs through the bore 28 of the cover 27f and has a flattened fastening portion 58 which is connectable with a tailgate for torque transmission. The cover 27f has an outside which can be pressed into the inside 34 of the housing for the cover 27f to be fixed. The sliding ring 14f is provided between the cover 27f and the rotary piston 19f.

For torque transmission from the rotary piston 19f to the friction disk 55, the free-running element 18f comprises several blocking units 59 which are disposed eccentrically of the axis of rotation 9. The blocking units 59 each comprise a first groove 60, a second groove 61 and a blocking ball 62 which is disposed in the grooves 60, 61 and guided thereby. The first groove 60 has the shape of a ramp in the friction disk 55, comprising a first groove bottom 63, which ascends in the direction of rotation 20, and a first groove rim 64, which encloses the bottom. The associated second groove 61 is opposite the first groove 60 in the rotary piston 19f, having a second groove bottom 65, which is flat in the direction of rotation 20, and a second groove rim 66, which encloses the bottom. At a first groove end 67, the first groove 60 has a maximum depth such that the sum of the depths of the first and second groove 60, 61 corresponds approximately to the diameter of the blocking ball 62. By contrast, the first groove 60, at a second groove end 68, has a minimum depth such that the diameter of the blocking ball 62 exceeds the sum of the depths of the first and second groove 60, 61 by one Δx.

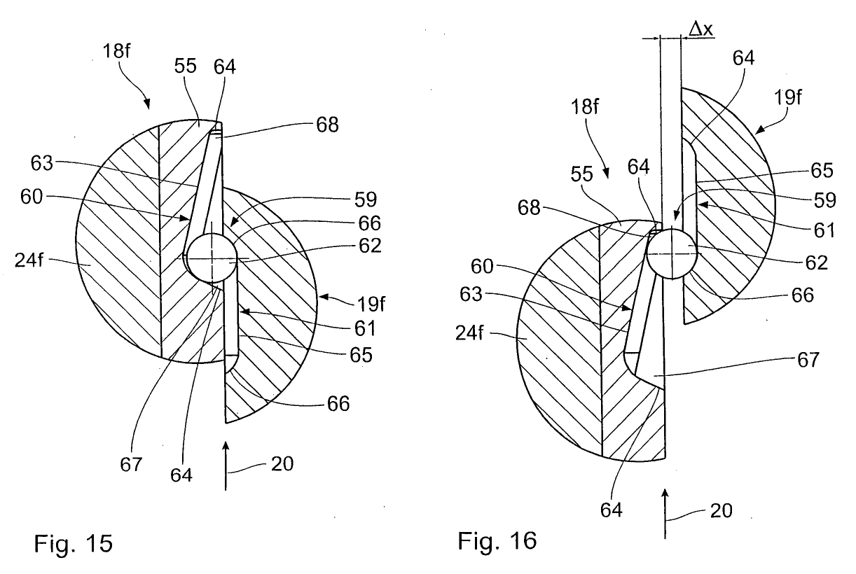

The mode of operation of the rotary damper 1f and the free-running element 18f will be described in detail below. FIG. 15 illustrates the free-running element 18f in a free-running position. In the free-running position, the blocking ball 62 of the illustrated blocking unit 59 bears against the groove rims 64, 66 in the vicinity of the first end 67 of the first groove 60. The blocking ball 62 is entirely accommodated in the grooves 60, 61 so that the free-running element 18f has a minimum extension along the axis of rotation 9. The cover 27f is pressed into the inside 34 of the housing in such a way that, in the free-running position, the friction disk 55 does not bear against the frictional damping lining 24f or only by some minor axial force that acts along the axis of rotation 9. Upon rotation of the rotary piston 19f against the direction of rotation 20, no torque is transmitted by the free-running element 18f to the frictional damping lining 24f and, consequently, no moment of friction is produced.

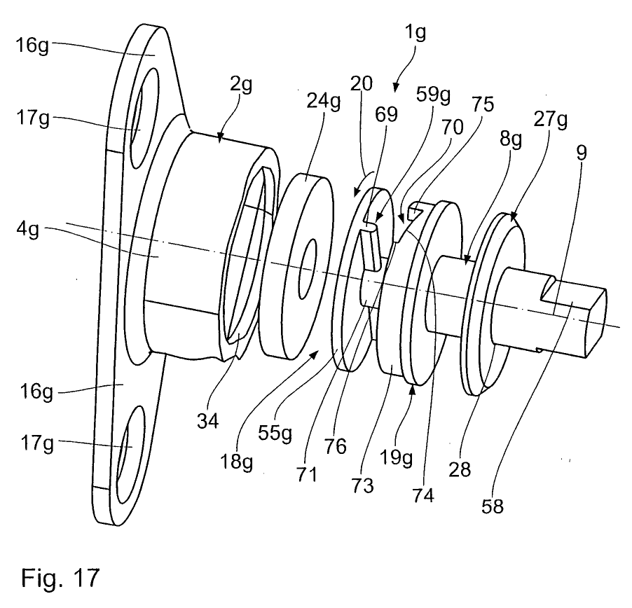

Upon rotation of the rotary piston 19f in the direction of rotation 20, the blocking ball 62 is entrained by the second groove rim 66 in the direction of rotation 20 so that it is moved along the first groove bottom 63, which ascends in the way of a ramp, towards the second groove end 68 where it bears against the groove rims 64, 66. This position is called position of friction and illustrated in FIG. 16. In the position of friction, the free-running element 18f has a maximum extension along the axis of rotation 9. By means of the blocking ball 62, the friction disk 55 is moved in relation to the rotary piston 19f by Δx along the axis of rotation in the direction of the frictional damping lining 24f. The friction disk 55 is thus pressed against the frictional damping lining 24f, so that a moment of friction is produced upon rotation in the direction of rotation 20. As for the further mode of operation, reference is made to the mode of operation of the foregoing embodiments.

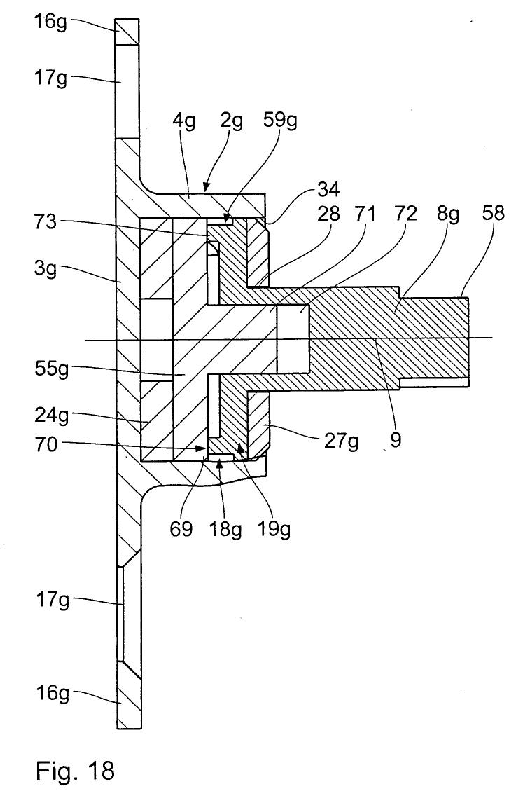

An eighth exemplary embodiment is going to be described below, taken in conjunction with FIGS. 17 and 18. Constructionally identical parts have the same reference numerals as in the first embodiment, to the description of which reference is made. Parts that differ constructionally, but are identical functionally, have the same reference numerals with a g annexed. The substantial difference from the foregoing embodiment resides in the design of the blocking units 59g of the free-running element 18g.

The blocking units 59g each comprise a blocking rib 69, which extends radially to the axis of rotation 9, and an associated groove 70. The blocking ribs 69 are formed in one piece with the friction disk 55g and turned towards the rotary piston 19g. Proceeding from a cylindrical friction-disk projection 71, the blocking ribs 69 extend as far as to the outer end of the friction disk 55g. The friction-disk projection 71 is disposed integrally on the friction disk 55g concentrically of the axis of rotation 9 and extends into a corresponding recess 72 of the shaft 8g. The grooves 70 are formed in an annular rotary-piston projection 73 opposite the associated blocking ribs 69. The rotary-piston projection 73 is disposed concentrically of the axis of rotation 9 and integrally on the rotary piston 19g. The grooves 70 ascend in the way of a ramp in the direction of rotation 20, having a bottom 74, a first stop 75 and a second stop 76. In the vicinity of the first stop 75, the grooves 70 have a maximum depth which corresponds to the height of the respectively associated blocking rib 69. As compared with this, the grooves 70 have a minimum depth in the vicinity of the second stop 76 so that the height of the respectively associated rib 69 is greater by one Δx. As in the embodiment according to FIG. 13, a sliding ring 14g can be provided between the cover 27g and the rotary piston 19g, having the same function as in the embodiment according to FIG. 13.

The mode of operation of the rotary damper 1g and of the free-running element 18g will be described below. In the position of free running, the blocking ribs 69 bear against the respectively associated first stop 75. They are entirely accommodated in the grooves 70 so that the free-running element 18g has a minimum extension along the axis of rotation 9. Corresponding to the preceding embodiment, the cover 27g is kept in position by pressing so that, upon rotation of the rotary piston 19g by the free-running element 18g against the direction of rotation 20, no torque is transmitted to the frictional damping lining 24g, there being no moment of friction.

Upon rotation of the rotary piston 19g in the direction of rotation 20, the blocking ribs 69 move along the associated bottoms 74 of ramp-type ascent until the blocking ribs 69 rest on the respectively associated second stops 76. In this position of friction, the free-running element 18g has its maximal extension along the axis of rotation 9. By means of the blocking ribs 69, the friction disk 55g is moved by Δx along the axis of rotation 9 in the direction of the frictional damping lining 24g. The friction disk 55b is thus pressed against the frictional damping lining 24g so that a moment of friction is produced upon rotation in the direction of rotation 20. As for the further mode of operation, reference is made to the preceding embodiments.

When the above-mentioned rotary dampers 1, 1a, 1b, 1c, 1d, 1e, 1f, 1g are employed for damping the motion of rotation of a tailgate, good damping behaviour and, with the rotary damper 1a, 1b, 1c embodied correspondingly, some aid in shutting the tailgate are achievable. Consequently, the rotary damper 1, 1a, 1b, 1c, 1d, 1e, 1f, 1g complies with a customer's increased demand for convenience while being fabricable at a low cost and extraordinarily reliable due to the unnecessary sealing.

The compressible frictional damping linings of the above-mentioned rotary dampers acts as friction elements on the one hand and as spring elements on the other. Depending on how the rotary damper is configured, these effects can be implemented separately or in combination. Corresponding selection of the material properties of the frictional damping linings ensures continuous transition from one effect to the other. If the frictional damping linings work predominantly as friction elements—as in the first, fifth, sixth, seventh and eighth embodiment—then damping takes place by the moment of friction. There is no supporting effect upon rotation against the direction of rotation. If the frictional damping linings work predominantly as spring elements—as in the third and fourth embodiment—then damping the motion of rotation is effected by the moment of spring as a result of the compression of the frictional damping linings. Depending on the angle of rotation, a moment of spring acts against the direction of rotation, acting in support of rotation against the direction of rotation. The frictional damping linings described in the second embodiment work as friction elements on the one hand and as spring elements on the other.

What is claimed is:

1. A rotary damper for damping a motion of rotation comprising
a. a housing (2; 2a; 2b; 2c; 2d; 2e; 2f; 2g);
b. a cover (27; 27b; 27c; 27d; 27e; 27f; 27g) which closes the housing (2; 2a; 2b; 2c; 2d; 2e; 2f; 2g);
c. a shaft (8; 8a; 8b; 8c; 8d; 8e; 8f; 8g) which is mounted in the housing (2; 2a; 2b; 2c; 2d; 2e; 2f; 2g) rotatably about an axis of rotation (9) and which is operable by a torque that is to be damped; and
d. at least one compressible frictional damping lining (24; 24a; 24b; 24c; 24d; 24e; 24f; 24g) which is disposed in the housing (2; 2a; 2b; 2c; 2d; 2e; 2f; 2g) and acts between the housing (2; 2a; 2b; 2c; 2d; 2e; 2f; 2g) and the shaft (8; 8a; 8b; 8c; 8d; 8e; 8f; 8g) for damping a motion of rotation of the shaft (8; 8a; 8b; 8c; 8d; 8e; 8f; 8g) along a direction of rotation (20).

2. A rotary damper-according to claim 1, wherein the at least one frictional damping lining (24; 24a; 24b; 24c; 24d; 24e; 24f; 24g) consists of an elastomer, in particular polyurethane.

3. A rotary damper according to claim 1, wherein the at least one damping lining (24; 24a; 24b; 24c; 24d; 24e; 24f; 24g) has a density ranging between 250 kg/m³ and 750 kg/m³, in particular between 350 kg/m³ and 650 kg/m³, and in particular between 450 kg/m³ and 550 kg/m³.

4. A rotary damper according to one of claim 1, wherein a rotary piston (19; 19a; 19b; 19c; 19d; 19e; 19f; 19g) is provided for arrangement of the at least one frictional damping lining (24; 24a; 24b; 24c; 24d; 24e; 24f; 24g).

5. A rotary damper according to claim 4, wherein the rotary piston (19b) is formed integrally on the cover (27b).

6. A rotary damper according to claim 1, wherein at least a first stop (25; 25a; 25b; 25c; 25d; 25e) and a second stop (26; 26a; 26b; 26c; 26d; 26e) are provided for holding the at least one frictional damping lining (24; 24a; 24b; 24c; 24d; 24e; 24f; 24g).

7. A rotary damper according to claim 6, wherein the first stop (25a; 25b; 25c) and the second stop (26a; 26b; 26c) are rotatable one in relation to the other for compression of the at least one frictional damping lining (24a; 24b; 24c).

8. A rotary damper according to claim 6, wherein at least one stop (25a; 25b; 25c) is fixed to the housing (2a; 2b; 2c) and at least one stop (26a; 26b; 26c) is fixed to the rotary piston (19a; 19b; 19c).

9. A rotary damper according to claim 1, wherein a free-running element (18; 18f; 18g), which acts against the direction of rotation (20), is disposed concentrically of the axis of rotation (9).

10. A rotary damper according to claim 1, wherein a spring element (43) is provided for producing a moment of spring.

11. A rotary damper according to claim 1, wherein the at least one frictional damping lining (24; 24a; 24b; 24c; 24d; 24e; 24f; 24g) is constructed such that it damps a motion of rotation of the shaft (8; 8a; 8d; 8e; 8f; 8g) substantially by friction.

12. A rotary damper according to claim 1, wherein the frictional damping lining (24a; 24b; 24c) is constructed such that a motion of rotation of the shaft (8a; 8b; 8c) is damped substantially by flexible compression of the frictional damping lining (24a; 24b; 24c).

13. A rotary damper according to claim 1, wherein ribs (52) in the shape of a ramp, which extend radially outwards, are disposed on one of the housing (2e) and the cover (27e).

14. A rotary damper according to claim 9, wherein the free-running element (18f; 18g) is disposed between the at least one frictional damping lining (24f; 24g) and the rotary piston (19f; 19g) along the axis of rotation (9).

15. A rotary damper according to claim 9, wherein the free-running element (18f; 18g) comprises at least one friction disk (55; 55g), which is concentric of the axis of rotation (9), and at least one blocking unit (59; 59g), which is eccentric of the axis of rotation (9).

16. A rotary damper according to claim 9, wherein the free-running element (18f; 18g) comprises at least one blocking unit (59; 59g) which has a groove (60; 70) that ascends in the way of a ramp in the direction of rotation (20).

17. A rotary damper according to claim 9, wherein the free-running element (18f; 18g) and the rotary piston (19f; 19g) are movable one in relation to the other at least partially along the axis of rotation (9).
